(19) United States
(12) Patent Application Publication
(10) Pub. No.: US 2023/0107632 A1
(43) Pub. Date: Apr. 6, 2023

(54) DATABASE RELATIONSHIP DISCOVERY

(71) Applicant: BRITISH TELECOMMUNICATIONS PUBLIC LIMITED COMPANY, London (GB)

(72) Inventors: Akinola OGUNSEMI, London (GB); Mathias KERN, London (GB); John MCCALL, London (GB); Gilbert OWUSU, London (GB); Benjamin LACROIX, London (GB); David CORSAR, London (GB)

(21) Appl. No.: 17/908,664

(22) PCT Filed: Feb. 23, 2021
(86) PCT No.: PCT/EP2021/054385

§ 371 Date: Sep. 1, 2022

(30) Foreign Application Priority Data
Mar. 1, 2020 (EP) 20160295.0

(51) Int. Cl. G06F 16/21

(52) U.S. Cl. CPC G06F 16/211

(57) ABSTRACT

A computer implemented method of identifying one or more relationships between columns in a database by determining a subset of a set of all columns of all tables in the database, the columns in the subset satisfying predetermined primary key characteristics, each predetermined characteristic being defined by a rule for identifying a column as a potential primary key; identifying one or more relationships between columns in the subset and columns in the set of all columns based on each of: primary key and foreign key relationships between columns; and relationships between columns indicated in one or more scripts, each script including instructions for accessing the database.

### PRIORITY CLAIM

The present application is a National Phase entry of PCT Application No. PCT/EP2021/054385, filed Feb. 23, 2021, which claims priority from EP Patent Application No. 20160295.0, filed Mar. 1, 2020, each of which is hereby fully incorporated herein by reference.

### TECHNICAL FIELD

The present disclosure relates to the automatic discovery of relationships between database tables.

### BACKGROUND

Organizations employ databases storing information, such as information about business processes. It is increasingly common for knowledge about the structure and content of such databases to be lacking or not available at all. For example, legacy databases may be undocumented and staff familiar with their design and implementation may have moved-on. This can make the interpretation and exploitation of information stored in such databases very challenging.

Current approaches to addressing the determination of relationships between databases rely on close inspection of data stored in database tables and explicit relationships between tables. Such approaches often require intensive human analysis. To the extent that such processes may be automated, the need to characterize data types and contents within database tables involves processing large volumes of stored data to define bounds and formats of fields.

### SUMMARY

Accordingly, it is beneficial to provide improvements to the identification of relationships between data stored in databases.

According to a first aspect of the present disclosure, there is provided a computer implemented method of identifying one or more relationships between columns in a database, the method comprising: determining a subset of a set of all columns of all tables in the database, the columns in the subset satisfying predetermined primary key characteristics, each predetermined characteristic being defined by a rule for identifying a column as a potential primary key; identifying one or more relationships between columns in the subset and columns in the set of all columns based on each of: primary key and foreign key relationships between columns; and relationships between columns indicated in one or more scripts, each script including instructions for accessing the database.

In some embodiments, the rule of a primary key characteristic includes one or more of: a requirement that a column is explicitly identified as a primary key; a requirement that data stored in a column is alphanumeric; a requirement that each data item stored in the column is absent null data; a requirement that each data item stored in the column is unique within the column; and a requirement that each data item stored in the column is comprised of a predetermined subset of characters.

In some embodiments, a primary key and foreign key relationship is identified for a first and second columns by one or more of: an explicit identification that the first column is a primary key and the second column is a corresponding foreign key; and a determination that the second column includes data items storing only values that appear in the first column.

In some embodiments, a script indicates a relationship between a first and second columns by the script including a statement that links the two columns such as a database join statement.

In some embodiments, the columns in the subset are modelled in a data structure including an element for each column, and wherein identifying one or more relationships between columns in the subset and columns in the set of all columns further comprises: identifying a column in the subset as related to a column in the set of all columns; modelling the related column in the set of all columns as an element in the data structure; and modelling the relationship between the column in the subset and the column in the set of all columns in the data structure.

In some embodiments, the modelled relationship in the data structure is adapted to indicate a confidence of the relationship, the confidence being based on how the relationship was identified.

According to a second aspect of the present disclosure, there is provided a computer system including a processor and memory storing computer program code for performing the method set out above.

According to a third aspect of the present disclosure, there is provided a computer program element comprising computer program code to, when loaded into a computer system and executed thereon, cause the computer to perform the method as described above.

### BRIEF DESCRIPTION OF THE DRAWINGS

Embodiments of the present disclosure will now be described, by way of example only, with reference to the accompanying drawings, in which:

FIG. 1 is a block diagram a computer system suitable for the operation of embodiments of the present disclosure.

FIG. 2 is a component diagram of an arrangement for identifying relationships between columns in a database in accordance with an embodiment of the present disclosure.

FIG. 3 is a flowchart of a method for identifying relationships between columns in a database in accordance with an embodiment of the present disclosure.

### DETAILED DESCRIPTION

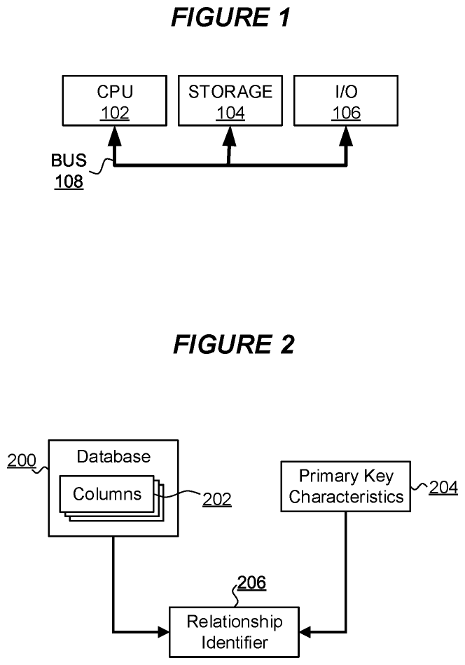

FIG. 1 is a block diagram of a computer system suitable for the operation of embodiments of the present disclosure. A central processor unit (CPU) 102 is communicatively connected to a storage 104 and an input/output (I/O) interface 106 via a data bus 108. The storage 104 can be any read/write storage device such as a random-access memory (RAM) or a non-volatile storage device. An example of a non-volatile storage device includes a disk or tape storage device. The I/O interface 106 is an interface to devices for the input or output of data, or for both input and output of data. Examples of I/O devices connectable to I/O interface 106 include a keyboard, a mouse, a display (such as a monitor) and a network connection.

FIG. 2 is a component diagram of an arrangement for identifying relationships between columns in a database in accordance with an embodiment of the present disclosure. Database 200 is a relational database as a data storage mechanism implemented by way of one or more defined database tables each including one or more database columns 202. For example, the database 200 is a database implemented using an Oracle database or a DB2 database (Oracle and DB2 are trademarks or registered trademarks of their respective owners). Each database column 202 has associated a column name as an identifier of the database, such as is typically implemented as an alphanumeric string, textual or other string of characters for uniquely identifying a column within a database table. Additionally, each database column 202 has a data type associated therewith defining the type or types of data that may be stored in that column. Thus, in use, data records are storable within database tables such that data is stored for a record in each of one or more columns of a database table.

Embodiments of the present disclosure provide for the identification of relationships between columns 202 in a database. Notably, the columns 202 in FIG. 2 are depicted without regard to database tables though it will be appreciated by those skilled in the art that each column 202 will be constituted as a column of a database table within the database 200.

A relationship identifier 206 component is provided as a hardware, software, firmware or combination component configured to identify one or more relationships between columns 202 in the database 200. The relationship identifier is operable to determine a subset of all columns 202 satisfying predetermined primary key characteristics 204. The primary key characteristics 204 are characteristics of a column within a database table indicative of the column being a primary key for the database table. As will be apparent to those skilled in the art, a primary key in a database table can be a column that is used to uniquely identify a record in a relational database table.

In embodiments of the present disclosure, each primary key characteristic 204 includes a rule for identifying a column as a primary key. For example, the rule of a primary key characteristic 204 can include a requirement that a column is explicitly identified as a primary key, such as by being indicated as such in a definition of the column for a database table. Additionally or alternatively, the rule of a primary key characteristic 204 can include a requirement that data stored in a column is alphanumeric. This reflects a common requirement that primary key data is alphanumeric in various databases. Additionally or alternatively, the rule of a primary key characteristic 204 can include a requirement that each data item stored in the column is absent NULL data. That is, that data stored in the column is NOT NULL, or that the column is indicated as a NOT NULL column. Such an indication precludes the storage of NULL in the column within records stored in a database table as a primary key cannot be a NULL value. Additionally or alternatively, the rule of a primary key characteristic 204 can include a requirement that each data item stored in the column is unique within the column. Additionally or alternatively, the rule of a primary key characteristic 204 can include a requirement that each data item stored in the column is comprised of a predetermined subset of characters, such as WORD characters that can be characterized as all alphanumeric characters and an underscore character. For example, the predetermined subset of characters can exclude whitespaces and special characters, for example, as is typical among primary key columns of databases.

Thus, the relationship identifier 206 identifies a subset of columns 202 satisfying the primary key characteristics 204. Subsequently, the relationship identifier 206 is operable to identify relationships between the columns in the identified subset of columns and the set of all columns 202. The relationships can be identified based on primary key and foreign key relationships between the columns Additionally, the relationships can be identified based on indications of relationship in scripts including instructions for accessing the database 200.

A primary key and foreign key relationship can be identified for a first and second columns by, for example, an explicit identification that the first column is a primary key and the second column is a corresponding foreign key. Additionally or alternatively, a primary key and foreign key relationship can be identified by a determination that the second column includes data items storing only values that appear in the first column.

Scripts including instructions for accessing the database 200 can include, for example, inter alia, existing scripts extracted from the database 200 or software interfacing with or using the database 200. For example, such scripts can include existing database logic such as procedures, functions, views or user queries. From such scripts, columns that co-occur in linking tables together can be identified such as script instructions involving table JOIN or the like. Such scripts provide indications of relationships between columns

In one embodiment, the relationship identifier 206 models the columns in the identified subset in a data structure, such as a graph data structure in which elements such as nodes in the data structure correspond to columns. Using such a data structure, the relationship identifier 206 can indicate or identify relationships between columns in the subset and columns in the set of all columns 200 by modelling identified relationships as relationships in the data structure. In particular, related columns can be indicated in the data structure and relationships can be indicated by, for example, edges in a graph data structure. Furthermore, indications of relationship in the data structure can be further supplemented by an indication of a degree of confidence of the relationship, such as by evaluating a degree of confidence depending on how the relationship was identified. For example, an explicitly indicated primary and foreign key relationship can provide a high degree of confidence; whereas an inferred relationship based on stored data or script information can provide a relatively lesser degree of confidence.

Thus, in use, the relationship identifier 206 is operable to identify relationships between pairs of columns in the database 200. Such relationships are especially valuable where the database 200 is otherwise undocumented or poorly understood since it serves to indicate commonality of entities represented by records in the database 200 by commonality of related columns For example, records stored in a first database table having a column determined to be related to a second database table can be associated with the records in the second database table based on the column relationship. Accordingly, new representations of data in the database 200 can be generated, new queries can be formulated and software can exploit data stored in the database 200 more efficiently.

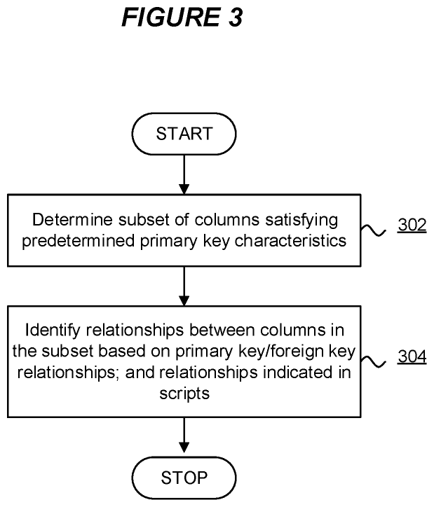

FIG. 3 is a flowchart of a method for identifying relationships between columns in a database in accordance with an embodiment of the present disclosure. Initially, at 302, the method determines a subset of all columns 202 of all tables in the database. The columns in the subset are determined based on predetermined primary key characteristics 204 defining rules for identifying a column as a potential primary key. Subsequently, at 304, the method identifies relationships between columns in the subset and columns 202 in the set of all columns The identification at 304 is based on: primary key and foreign key relationships between columns; and relationships between columns indicated in one or more scripts.

An exemplary embodiment of the present disclosure is described below. In this embodiment, we first consider and extract information about primary keys that has already been explicitly defined for each table in the database model. In an ideal relational database, many or even all tables should contain a primary key, but in real-world databases this it is not always the case. Provided that this information already exists in the database for at least some tables, this can be accessed with pre-defined statements that retrieve the information of a database object that describes all constraint definitions on tables which are accessible to users. As shown in Algorithm 1, given a set of tables, a subset of tables with known primary keys are initially retrieved. We use a function to retrieve all tables with their respective primary keys if they exist.

In the next phase, we automatically infer, without any prior knowledge, potential primary key columns by using other information. Our inference is based on four tests, which are explained below:

### Test 1: Alphanumeric Datatype Test

The first test requires that a primary key must be of an alphanumeric datatype. We obtain a list of all tables in the database with their respective columns and datatypes, and then select tables with associated alphanumeric columns. In a typical Oracle database, this would include columns with datatypes such as char, number, nchar, varchar, nvarchar, varchar2 and nvarchar2.

### Test 2: Nullability Test

One of the major constraints that defines a primary key is a NOT NULL constraint which means that a primary key must not be empty (null). This information might not be explicitly defined for a table but we can infer by checking for non-null columns of each table in the database. For example, a statement is embedded in the algorithm to retrieve a null value from each column of a table. For each column, the algorithm checks whether the query returns an empty result or not. An empty result indicates that a column contains no empty/null values.

### Test 3: Uniqueness Test

For a column to be regarded as a potential primary key candidate, it must meet the uniqueness test—primary key column must only contain unique, i.e. not duplicate, values. Unique constraint definition enforces the uniqueness of a column by ensuring that no duplicate values exist in the column If this constraint has not already been defined explicitly in the database, a uniqueness test can be performed on each column in a table. If a column possesses the uniqueness property, then the total number of rows in the table must be equal to the number of distinct values in the column. In our algorithm, we establish both numbers and if they match, a column passes the uniqueness test.

### Test 4: Word Character Test

This test requires that values in a primary key column contain only “word” characters. For example, word characters include any letter, any digit and the underscore character. Some characters can be specifically excluded, such as whitespaces and special characters. Our algorithm retrieves all values for a column of a table and then use a check to establish whether each value consists of only word characters.

### Example of Primary Key Discovery with Example “Department” Table

Table 1 shows a typical sample table as may be found in a business database. It holds information about different departments and has four columns: Department_ID, Department_Name, Manager_ID and Location_ID. In this table, only the first column Department_satisfies all four tests, and thus is identified as a potential primary key column.

TABLE 1
Department Table of HR Schema

| DEPARTMENT_ID | DEPARTMENT_NAME | MANAGER_ID | LOCATION_ID |
|---|---|---|---|
| 10 | Administration | 200 | 1700 |
| 20 | Marketing | 201 | 1800 |
| 30 | Purchasing | 114 | 1700 |
| 40 | Human Resources | 203 | 2400 |
| 50 | Shipping | 121 | 1500 |
| 60 | IT | 103 | 1400 |
| 70 | Public Relations | 204 | 2700 |
| 80 | Sales | 145 | 2500 |
| 90 | Executive | 100 | 1700 |
| 100 | Finance | 108 | 1700 |
| 110 | Accounting | 205 | 1700 |
| 120 | Treasury | | 1700 |
| 130 | Corporate Tax | | 1700 |
| 140 | Control And Credit | | 1700 |
| 150 | Shareholder Services | | 1700 |
| 160 | Benefits | | 1700 |
| 170 | Manufacturing | | 1700 |
| 180 | Construction | | 1700 |
| 190 | Contracting | | 1700 |
| 200 | Operations | | 1700 |
| 210 | IT Support | | 1700 |
| 220 | NOC | | 1700 |
| 230 | IT Helpdesk | | 1700 |
| 240 | Government Sales | | 1700 |
| 250 | Retail Sales | | 1700 |
| 260 | Recruiting | | 1700 |
| 270 | Payroll | | 1700 |

Department_ID:
   Meets Test 1: a numeric datatype
   Meets Test 2: not-null values
   Meets Test 3: unique values
   Meets Test 4: word character values only
Department_Name:
   Meets Test 1: a string datatype
   Meets Test 2: not-null values
   Meets Test 3: unique values
   Fails Test 4: contains whitespace character
Manager_ID:
   Meets Test 1: a numeric datatype
   Fails Test 2: contains null values
   Fails Test 3: non-unique values
   Meets Test 4: word character values only (if not-null)
Location_ID:
   Meets Test 1: a numeric datatype
   Meets Test 2: not-null values
   Fails Test 3: non-unique values
   Meets Test 4: word character values only

Primary—Foreign Keys Relationships
Let T be the set of all tables to be considered in a database; this might exclude special tables such as system tables.
Let C be the set of all columns of the tables in T.
A is the subset of C, A⊆C, which contains all columns which have been explicitly defined as primary key columns in the database.
B is the subset of C\A, B⊆C\A, which contains all columns with have been identified as potential primary key candidates The sets A and B do not share any columns.
Let X be the union of A and B: X=A∪B.
We can calculate a graph g₁ in which the nodes are the primary key/key candidate columns from X plus their associated foreign key columns, and two column nodes are linked in the graph if they are in a primary/foreign key candidate relationship as established by our approach.

To find all column pairs where one column is a primary key/key candidate from X and the other column is a corresponding foreign key column from another table in C, we distinguish two cases:

I. Either a column is explicitly marked as a foreign key in the database itself,

II. Or we need to establish a 100 percent one-to-one match between the two columns, meaning the second (foreign key) column can only contain values that appear in the first (primary key candidate) column.

Algorithm 1 outlines our approach. We establish first the set A of explicitly specified primary keys, then calculate set B of primary key candidates by checking all potential columns against the four individual tests, construct the union X=A∪B, and finally calculate all pairs of a) primary key/primary key candidate from set X and b) foreign key/foreign key candidate from set C.

The check w(cᵢ, cⱼ) returns 1 if two columns cᵢ and cⱼ are in a (potential) primary/foreign key relationship, and 0 otherwise:

$$w ( {c}_{i} , {c}_{j} ) = \{ \begin{matrix}0 & if table ( {c}_{i} ) = table ( {c}_{j} ) \\ 1 & if {c}_{i} ∈ A and {c}_{j} is explictely specified foreign key for {c}_{i} \\ 1 & if {c}_{i} ∈ B and {c}_{j} only contains values from {c}_{i} \\ 0 & otherwise\end{matrix}$$

Algorithm 1: PseudoPrimaryKey(T)

| | |
|---|---|
| 1 | Input: T |
| 2 | Initialize: C ← Columns(T) |
| 3 | Initialize: A ← Ø, B ← Ø, X ← Ø |
| 4 | Initialize: g₁ ← Ø |
| 5 | A ← Retrieve explicitly known primary key columns from C |
| 6 | B ← Retrieve alphanumeric columns from C\A |
| 7 | B ← Retrieve columns with not null values from B |
| 8 | B ← Retrieve unique columns from B |
| 9 | B ← Retrieve columns with only word character values from B |
| 10 | X ← A ∪ B |
| 11 | For each column cᵢ in X |
| 12 | For each column cⱼ in C |
| 13 | If w(cᵢ, cⱼ)= 1 Then add (cᵢ, cⱼ) to g₁ |
| 14 | End If |
| 15 | End For |
| 16 | End For |

As Algorithm 1 does an exhaustive search across the considered tables in a database, it can be computationally expensive. It is therefore possible to limit the set of tables to be considered for the detection of potential primary key candidates and/or potential foreign key candidates to a smaller subset of tables in T, in particular if an implementation is used in an interactive way of exploration.

### Implementation of Usage-Based Technique with Database Objects

The usage-based approach makes use of existing scripts extracted from a database. This can include existing database logic such as procedures, functions, views or user queries. From these scripts, we extract all pairs of columns that co-occur in linking tables together. In short, we exploit the fact that other, previous users have already created and used logic that links certain table columns together, and automatically infer that a meaningful link between these columns is likely to exist.

Let S be the set of existing scripts for a database: S={s₁, . . . , s_{q}}.

Each script sᵢ references a number of tables {tᵢ₁, . . . , tᵢₙ} in its logic.

If script sᵢ contains a link statement, e.g. a join statement, between tables tᵢₓ and t_{iy}, and more specifically links columns cᵢₓ and c_{iy} belonging to tables tᵢₓ and t_{iy}, we infer a link between those two columns.

If a link exists, we add the two columns as nodes to a graph g₂ and connect them in the graph.

The steps involved in the usage-based approach are provided in algorithm 2. We automatically identify from each script, all pairs of columns (cᵢₓ, c_{iy}) used by its logic to link two tables referenced in script sᵢ.

Algorithm 2: UsageBased(S)

| | |
|---|---|
| 1 | Input: S |
| 2 | Initialize g₂ ← 0 |
| 3 | For each sᵢ in S |
| 4 | For each tᵢₓ in sᵢ |
| 5 | For each t_{iy} in sᵢ |
| 6 | If cᵢₓ ∈ tᵢₓ and c_{iy} ∈ t_{iy} are used in |
| | linking tᵢₓ and t_{iy} in sᵢ Then add (cᵢₓ , c_{iy}) |
| | to g₂ |
| 7 | End If |
| 8 | End For |
| 9 | End For |
| 10 | End For |
| 11 | Return g₂ |

Combining the Two Approaches

By combining the two approaches, i.e. by overlaying the two graphs g₁ and g₂ extracted in Algorithms 1 and 2, we get a more comprehensive picture of the data structure and data links than we would if we used only one of the algorithms in isolation. This can be extended to include further (heuristic) approaches to establish relationships between table columns.

Furthermore, we can establish two additional parameters for each edge in the resulting overall graph, i.e. for each candidate relationship between two table columns:
Confidence: this parameter describes how confident we are that a discovered candidate relationship between two columns does indeed exists
   If the relationship was established due to a primary/foreign key relationship explicitly stated in the database, then confidence is high
   If the relationship was established due to a inferred primary/foreign key candidate relationship, then confidence is low to medium
   If the relationship was established due to two columns being linked in pre-existing script logic in the database, then confidence is medium to high
   If a relationship was established through different approaches, we use the highest confidence value
Frequency of the relationship: if the database provides access to usage statistics, we can extract how often—frequent—a particular script logic is used and run, and this gives us an indicator how frequent the extracted links are used

Both confidence and frequency values of relationship between table columns can be used to sort and prioritize the different relationship candidates, and thus help to look at the most certain and/or most frequently used relationship first, thereby providing an ordered series of relationships.

Insofar as embodiments of the disclosure described are implementable, at least in part, using a software-controlled programmable processing device, such as a microprocessor, digital signal processor or other processing device, data processing apparatus or system, it will be appreciated that a computer program for configuring a programmable device, apparatus or system to implement the foregoing described methods is envisaged as an aspect of the present disclosure. The computer program may be embodied as source code or undergo compilation for implementation on a processing device, apparatus or system or may be embodied as object code, for example.

Suitably, the computer program is stored on a carrier medium in machine or device readable form, for example in solid-state memory, magnetic memory such as disk or tape, optically or magneto-optically readable memory such as compact disk or digital versatile disk, etc., and the processing device utilizes the program or a part thereof to configure it for operation. The computer program may be supplied from a remote source embodied in a communications medium such as an electronic signal, radio frequency carrier wave or optical carrier wave. Such carrier media are also envisaged as aspects of the present disclosure.

It will be understood by those skilled in the art that, although the present disclosure has been described in relation to the above described example embodiments, the disclosure is not limited thereto and that there are many possible variations and modifications which fall within the scope of the disclosure.

The scope of the present disclosure includes any novel features or combination of features disclosed herein. The applicant hereby gives notice that new claims may be formulated to such features or combination of features during prosecution of this application or of any such further applications derived therefrom. In particular, with reference to the appended claims, features from dependent claims may be combined with those of the independent claims and features from respective independent claims may be combined in any appropriate manner and not merely in the specific combinations enumerated in the claims.

1. A computer implemented method of identifying one or more relationships between columns in a database, the method comprising:
determining a subset of a set of all columns of all tables in the database, the columns in the subset satisfying predetermined primary key characteristics, each predetermined primary key characteristic being defined by a rule for identifying a column as a potential primary key; and
identifying one or more relationships between the columns in the subset and the columns in the set of all columns based on each of:
primary key and foreign key relationships between the columns, and
relationships between columns indicated in one or more scripts, each of the one or more scripts including instructions for accessing the database.

2. The method of claim 1, wherein the rule for identifying a column as a potential primary key includes one or more of: a requirement that a column is explicitly identified as a primary key; a requirement that data stored in a column is alphanumeric; a requirement that each data item stored in the column is absent null data; a requirement that each data item stored in the column is unique within the column; and a requirement that each data item stored in the column is comprised of a predetermined subset of characters.

3. The method of claim 1, wherein the primary key and foreign key relationship is identified for a first column and a second column by one or more of:
an explicit identification that the first column is a primary key and the second column is a corresponding foreign key; or
a determination that the second column includes data items storing only values that appear in the first column.

4. The method of claim 1, wherein each of the one or more scripts indicates a relationship between a first column and a second column by the script including a statement that links the first column and the second column.

5. The method of claim 1, wherein the columns in the subset are modelled in a data structure including an element for each column, and wherein identifying one or more relationships between the columns in the subset and the columns in the set of all columns further comprises:
identifying a column in the subset as related to a column in the set of all columns;
modelling the related column in the set of all columns as an element in the data structure; and
modelling the relationship between the column in the subset and the column in the set of all columns in the data structure.

6. The method of claim 5, wherein the modelled relationship in the data structure is adapted to indicate a confidence of the relationship, the confidence being based on how the relationship was identified.

7. A computer system comprising:
a processor and memory storing computer program code for identifying one or more relationships between columns in a database by:
determining a subset of a set of all columns of all tables in the database, the columns in the subset satisfying predetermined primary key characteristics, each predetermined primary key characteristic being defined by a rule for identifying a column as a potential primary key; and
identifying one or more relationships between the columns in the subset and the columns in the set of all columns based on each of:
primary key and foreign key relationships between the columns, and
relationships between columns indicated in one or more scripts, each of the one or more scripts including instructions for accessing the database.

8. A non-transitory computer-readable storage medium comprising computer program code to, when loaded into a computer system and executed thereon, cause the computer system to identify one or more relationships between columns in a database by:
determining a subset of a set of all columns of all tables in the database, the columns in the subset satisfying predetermined primary key characteristics, each predetermined primary key characteristic being defined by a rule for identifying a column as a potential primary key; and
identifying one or more relationships between the columns in the subset and the columns in the set of all columns based on each of:
primary key and foreign key relationships between the columns, and
relationships between columns indicated in one or more scripts, each of the one or more scripts including instructions for accessing the database.

9. The method of claim 4, wherein the statement that links the first column and the second column is a database join statement.
